(19) United States
(12) Patent Application Publication
(10) Pub. No.: US 2005/0118083 A1
(43) Pub. Date: Jun. 2, 2005

(54) Process for the production of lithium-containing material and non-aqueous electrolyte electrochemical cells using it

(75) Inventor: Toru Tabuchi, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: JAPAN STORAGE BATTERY CO., LTD.

(21) Appl. No.: 10/933,512

(22) Filed: Sep. 3, 2004

(30) Foreign Application Priority Data
Sep. 5, 2003 (JP) P. 2003-314450
Sep. 11, 2003 (JP) P. 2003-319716

(51) Int. Cl. C01D 15/00; H01M 10/04; H01M 4/04

(52) U.S. Cl. 423/179.5; 29/623.1

(57) ABSTRACT

One of the present invention is a process for a production of lithium-containing material by a lithium absorption reaction proceeding on contact between material M and a solution obtained by dissolving metallic Li and polycyclic aromatic compound into chain monoether, where the material M contains at least one sort of elements selected from a transition metal, IIIb metal, IVb metal, and Vb metal in a periodic table. One of a present invention is a process for a production of a non-aqueous electrolyte electrochemical cell using an electrode with the lithium-containing material.

### TECHNICAL FIELD

The present invention relates to a process for a production of a lithium-containing material and non-aqueous electrolyte electrochemical cell using it.

### BACKGROUND OF ART

In recent years, the small and lightweight Li-ion cells have been widely used as a power source of electric devices such as cellular phone and digital camera. Since multi-functionalization of such electric device has remarkably progressed, improvement in the energy density of the cells has been further expected.

A lithium transition metal oxide as positive active material and a carbon as negative active material have been mainly used for commercial Li-ion cells until now. As candidates of other positive active materials, there are TiS₂, MoS₂, MnO₂, V₂O₅, etc, which have been until now studied for the practical use. However, lithium contributing to charge-discharge reaction is not contained in these positive active materials. Therefore, these positive active materials have the problem that they have to combine with negative active materials containing lithium for establishment of Li-ion cells.

Although metallic lithium and lithium alloy have been considered as one of the negative active material, these can not have been used due to poor cycle performance. In addition, if a carbon is used as a negative active material, it needs to be made to contain lithium in advance. To manufacture this lithium-containing carbon material LixC (X>0), the electrochemical method is required that cathode reaction is carried out by using the suitable counter electrode with such a metallic lithium in the electrolyte containing Li⁺ ion, as the Japanese published unexamined patent 2002-075454 reported. This method has to prepare the electrode with carbon and to charge it electrically, in advance. Therefore, the complicated attachment work of a lead and voltage-current control equipment are required, which means high manufacturing cost. Moreover, since the LixC (X>0) is remarkably unstable to water and air, there is a problem in handling. The method of attaching metallic lithium directly on electrode as indicated by the Japanese published unexamined patent 2002-075454 also has a problem that the process is complicated and requires the long time.

On the other hand, if a carbon material which does not contain lithium is used as a negative active material, attachment of metallic lithium to electrode or electrochemical method is not required. However, lithium contributing to charge-discharge reaction has to be included in positive active material in this case.

Therefore, for preparation of the lithium-containing positive active material, the electrochemical method is required that cathode reaction is carried out by using the suitable counter electrode such a metallic lithium in the electrolyte containing Li⁺ ion in the same way as the manufacturing process of LixC (X>0). In this case, there is the same problem as the manufacturing process of LixC (X>0).

The Japanese patent No.3227771 and published unexamined patent Hei.8-203525 reported that in the cell using the positive electrode with lithium-containing material such a LiCoO₂ or LiNiO₂ and negative one with carbon, chemical absorption of lithium equivalent to the irreversible capacity of a carbon material to these positive active material compensates the irreversible capacity. Thus, these patents show that lithium consumed in the irreversible reaction is compensated by the invention, while it has not been examined and has been completely unknown that lithium absorbed to a non-lithium-containing material can contribute to charge-discharge reaction of positive or negative electrode.

If an easy, short, or low-cost lithium absorption method is to be established, there is another advantage. Recently, since the designed capacity of negative electrode with carbon has become the value near the theoretical capacity, it is difficult to enhance the discharge capacity of Li-ion cells in the future. Therefore, alternative negative active materials with large capacity to carbon have been studied extensively. SiO is one of the negative active materials as published unexamined patent Hei.8-130011 reported. However, there has been a problem that the cell thickness increases since the electrode with SiO has large volume expansion with charging. There has been also the problem of volume expansion with charging for SnO₂, SnO, ZnO, etc.

As one of solution of the problem, if the volume of active materials is, in advance, to be expanded by lithium absorption before fabrication of the cells, the increase of cell thickness can be limited. Thus, it is also very important to establish an easy, short, or low-cost lithium absorption method.

### SUMMARY OF THE INVENTION

The manufacturing process for lithium-absorption into non-lithium-containing material has been desired for contribution to charge-discharge reaction. The non-aqueous electrolyte electrochemical cell with it such as battery or capacitor has been also desired. The problem has been unsolved that cell thickness increases since the electrode with large-capacity negative active materials such as SiO, SnO₂, SnO, ZnO, etc. has large volume expansion with charging.

This invention offers A process for a production of lithium-containing active material and non-aqueous electrolyte electrochemical cells using it to solve these problems.

The first invention is a process for a production of lithium-containing material by a lithium absorption reaction proceeding on contact between material M and a solution obtained by dissolving metallic Li and polycyclic aromatic compound into chain monoether, where the material M contains at least one sort of elements selected from a transition metal, IIIb metal, IVb metal, and Vb metal in a periodic table.

The second invention is the process for the production of lithium-containing material according to first invention, where the molecule structure of the chain monoether is asymmetric.

The third invention is the process for the production of lithium-containing material according to first invention, where the chain monoether is 1-methoxy-butane.

The forth invention is the process for the production of lithium-containing material according to first invention, where the polycyclic aromatic compound is at least one sort selected from naphthalene, phenanthrene, and anthracene.

The fifth invention is the process for the production of lithium-containing material according to first invention, where the polycyclic aromatic compound is naphthalene.

The sixth invention is the process for the production of lithium-containing material according to first invention, where the material M is at least one sort selected from SiO, GeO, GeO₂, PbO, PbO₂, Pb₂O₃, Pb₃O₄, Sb₂O₃, Sb₂O₄, Sb₂O₅, Bi₂O₃, Bi₂O₄, Bi₂O₅, SnO, SnO₂, SnSi_{0.01}O_{1.09}, SnGe_{0.01}O_{1.09}, SnPb_{0.01}O_{1.09}, SnP_{0.01}O_{1.09}, SnB₂O₄, SnSiAl_{0.2}P_{0.2}O_{0.3}, In₂O₃, Tl₂O, Tl₂O₃, SnS, SnS₂, GeS, GeS₂, Sb₂S₅, Si₃N₄, AlN, CoO, CO₃O₄, CO₂O₃, NiO, TiO₂, TiO, MnO, CuO, Cu₂O, ZnO, CoS, Mn₂P, CO₂P, Fe₃P As₂O₃, V₂O₃, V₂O₄, V₂O₅, CrO₃, Cr₂O₃, Mn₂O₃, Mn₃O₄, MnO₂, Fe₃O₄, Fe₂O₃, FeO, FeS₂, CoS₂, TiS₂, FePO₄, CoPO₄, MnPO₄, NiF₃, and CoF₃.

The seventh invention is the process for the production of lithium-containing material according to first invention, where the material M is SiO.

The eighth invention is the process for the production of lithium-containing material according to first invention, where the material M is at least one sort selected from FePO₄, CoPO₄, and MnPO₄.

The ninth invention is a process for a production of a non-aqueous electrolyte electrochemical cell using an electrode with the lithium-containing material according to the first invention.

The tenth invention is the process for the production of the non-aqueous electrolyte electrochemical cell according to the ninth invention, using the electrode with the lithium-containing material obtained by the process according to the second invention.

The eleventh invention is the process for the production of the non-aqueous electrolyte electrochemical cell according to the ninth invention, using the electrode with the lithium-containing material obtained by the process according to the third invention.

The twelfth invention is the process for the production of the non-aqueous electrolyte electrochemical cell according to the ninth invention, using the electrode with the lithium-containing material obtained by the process according to the forth invention.

The thirteenth invention is the process for the production of the non-aqueous electrolyte electrochemical cell according to the ninth invention, using the electrode with the lithium-containing material obtained by the process according to the fifth invention.

The fourteenth invention is the process for the production of the non-aqueous electrolyte electrochemical cell according to the ninth invention, using the electrode with the lithium-containing material obtained by the process according to the sixth invention.

The fifteenth invention is the process for the production of the non-aqueous electrolyte electrochemical cell according to the ninth invention, using the electrode with the lithium-containing material obtained by the process according to the seventh invention.

The sixteenth invention is the process for the production of the non-aqueous electrolyte electrochemical cell according to the ninth invention, using the electrode with the lithium-containing material obtained by the process according to the eighth invention.

### DETAILED DESCRIPTION OF THE INVENTION

The manufacturing method of the lithium-containing material of these inventions is to make material M absorb lithium by contact between the solution S, which is obtained by dissolving metallic lithium and polycyclic aromatic compounds into chain monoether, and the material M containing at least one sort of elements selected the transition metal, IIIB metal, Si, Ge, Sn, Pb, As, Sb, Bi in the periodic table.

Moreover, the non-aqueous electrolyte electrochemical cells such a battery or capacitor etc. are equipped with the electrode using lithium-containing material obtained by the manufacturing process of present inventions.

Since it is possible for the lithium-containing material, which is obtained by contact between material M and solution S, to absorb and disabsorb lithium electrochemically, the non-aqueous electrolyte electrochemical cells are to be established by using the electrode with this material.

The element contained in material M is desirable to be one sort at least selected from Ti, V, Cr, Mn, Fe, Co, Ni, Zn, Nb, Si, Ge, Sn, Pb, and Sb since the charge-discharge characteristics of the non-aqueous electrolyte electrochemical cells is better. Furthermore, it is one sort at least selected from Mn, Fe, Co, and Si preferably.

Even if the electrode and solution S are contacted after preparing the electrode, or the electrode is prepared after contacting material M and solution S, ether cases are to be applied.

If metallic lithium and polycyclic aromatic compounds are dissolved in chain monoether, an electron moves from metallic lithium to polycyclic aromatic compounds and the complex solution is obtained after anion and lithium ion is formed. Therefore, in the case of dissolving all metallic lithium in this solution S, lithium ion, polycyclic aromatic compound, anion of polycyclic aromatic compound, and solvent are contained in the solution. In the case of dissolving the part of metallic lithium in this solution S, metallic lithium, lithium ion, polycyclic aromatic compound, anion of polycyclic aromatic compound, and solvent are contained in the solution. Then, lithium ion is absorbed to material M at the same time an electron moves from the anion of polycyclic aromatic compound to material M. Since anion of polycyclic aromatic compounds returns to polycyclic aromatic compounds at this time, it has the role of a catalyst in this lithium-absorption reaction.

The concentration of lithium in the solution S is desirable in the range from 0.07 g dm⁻³ to saturation. If the concentration is smaller than 0.07 g dm⁻³, the problem arises that absorption time becomes long. Lithium-saturated concentration is more desirable to shorten the absorption time.

The concentration of the polycyclic aromatic compounds in the solution S is desirable in the range from 0.005 to 2.0 mol dm⁻³. It is from 0.005 to 0.25 mol dm⁻³ more preferably, and from 0.005 to 0.01 mol dm⁻³ still more preferably. If the concentration of polycyclic aromatic compounds is smaller than 0.005 mol dm⁻³, the problem arises that absorption time becomes long. On the other hand, if the concentration is larger than 2.0 mol dm⁻³, the problem arises polycyclic aromatic compounds is precipitated in the solution.

The time that solution S and material M are contacted is not restricted. However, it requires 0.5 minutes or more for material M to absorb lithium fully. The time is in the range from 0.5 minutes to 240 hours more preferably, and from 0.5 minutes to 72 hours still more preferably.

Lithium-absorption rate is to be accelerated by stirring the solution in the case of the immersion material M into solution S. Moreover, if the temperature of solution S becomes high, lithium-absorption rate is to be accelerated; however the temperature is desirable below boiling point of the chain monoether not to boil the solution.

The material M in these inventions are the compounds containing the one element of sort selected from Al, Ga, In, Tl, Si, Ge, Sn, Pb, As, Sb, and Bi, such as oxides of GeO, GeO₂, PbO, PbO₂, Pb₂O₃, Pb₃O₄, Sb₂O₃, Sb₂O₄, Sb₂O₅, Bi₂O₃, Bi₂O₄, Bi₂O₅, SnO, SnO₂, SnSiO_{0.01}O_{1.09}, SnGe_{0.01}O_{1.09}, SnPb_{0.01}O_{1.09}, SnP_{0.01}O_{1.09}, SnB₂O₄, SnSiAl_{0.2}P_{0.2}O_{0.3}, In₂O₃, Tl₂O, Tl₂O₃, As₂O₃ etc., sulfides of SnS, SnS₂, GeS, GeS₂, Sb₂S₅, etc., nitride of Si₃N₄, and AlN etc., these compound containing at least one sort selected from representative nonmetal elements such as N, P, F, Cl, Br, I, S etc., and transition metal such as Sc, Ti, V, Cr, Mn, Fe, Co, Ni, Cu, Mo, Zr, Ta, Hf, Nb, W, etc. In addition, the use of SiO containing SiO₂ and Si phase is preferable among the oxides represented as SiOx (0≦X≦2). The half maximum full width B of the main peak (2θ) detected in the range from 46° to 49° is preferably represented as B<3° by XRD analysis with CuKα.

Examples of the material M in the present invention are oxides containing one sort at least selected from transition-metal oxide such as CoO, CO₃O₄, CO₂O₃, CoPO₄, NiO, TiO₂, TiO, V₂O₃, V₂O₄, V₂O₅, CrO₃, Cr₂O₃, MnO, MnO₂, Mn₂O₃, Mn₃O₄, FeO, Fe₂O₃, Fe₃O₄, CuO, Cu₂O, ZnO, etc., fluoride such as CoF₃, NiF₃, etc., sulfide such as TiS₂, FeS₂, CoS, etc., nitride Fe₃N, etc., phosphide such as Mn₃P, CO₃P, Fe₃P, and their derivatives including one sort selected from representative nonmetal element such as B, N, P, Cl, Br, I, etc., and representative metal element such as Mg, Al, Ca, Ga, Ge, Sn, Pb, Bi, etc.

The material M is to be used with one or more mixtures. Their crystallinity is to be used from high to amorphous. Their figuration is to be used as particle, film, fiber, and mesoporous.

The material M is to be used as composite with carbon. The composite coated with carbon on the surface of material M, granulated by mixing with carbon and material M, and coated with carbon on the surface of the particle granulated by mixing with carbon and material M are to be used. As the carbon coating, CVD method where the surface of particles is deposited chemically in the vapor phase using carbon sources such as benzene, toluene, xylene, methane, ethane, propane, butane, ethylene, acetylene, etc., heating method after mixing with thermoplastic resin such as pitch, tar, furfurylalcohol, etc., mechanical reaction method between their particle and carbon are to be used. CVD method is preferable because of uniformly coating.

The lithium-containing material of the present invention is to be used for the only positive electrode, only negative electrode, or both positive and negative electrode of non-aqueous electrolyte electrochemical cell.

In the case of using the lithium-containing material for positive electrode of the non-aqueous electrolyte electrochemical cell, there is no restriction for negative active material, which various materials selected from carbon material such as graphite, amorphous carbon, etc., oxide, nitride are to be used.

In the case of using the lithium-containing material for negative electrode of the non-aqueous electrolyte electrochemical cell, there is no restriction for positive active material, which various materials selected from transition metal oxide such as manganese dioxide, vanadium pentoxide, etc., transition metal chalcogen such as ferric sulfide, titanium sulfide, etc., carbon material such as graphite, active carbon, etc. are to be used.

Examples of the binder to be used for the positive and negative electrode include one sort at least selected from ethylene-propylene-diene ternary copolymer, acrylonitrile-butadiene rubber, fluorocarbon rubber, polyvinyl acetate, polymethylmethacrylate, polyethylene, nitrocellulose, polyvinylidene fluoride, polyethylene, polypropylene, polytetrafluoroethylene, tetrafluoroethylene-hexafluoropropylene copolymer, polyvinylidene fluoride-chlorotrifluoroethylene copolymer, styrene-butadiene rubber (SBR), carboxymethylcellulose, etc.

Non-aqueous and aqueous solvents are to be used for the solvent to be used for mixing a binder. Examples of the non-aqueous solvent include N-methyl-2-pyrrolidone, dimethyl formamide, dimethylacetamide, methylethylketon, cyclohexanone, methyl acetate, methyl acrylate, diethyltriamine, N,N-dimethylaminopropylamine, ethylene oxide, tetrahydrofuran. Aqueous solvent is to be used with adding of dispersion or rheology control agent.

Examples of the current collector for the positive and negative electrodes include iron, copper, stainless steel, nickel, and aluminum. The shape of these collectors is to be used with sheet, foam, mesh, porous, expanded grid, etc.

Examples of the non-aqueous solvent for electrolyte include ethylenecarbonate, propylenecarbonate, butylenecarbonate, trifluoropropylenecarbonate, γ-butyrolactone, sulfolane, 1,2-dimethoxyethane, 1,2-diethoxyethane, tetrahydrofuran, 3-methyl-1,3-dioxolane, methylacetate, ethylacetate, methylpropionate, ethylpropionate, dimethylcarbonate, diethylcarbonate, ethylmethylcarbonate, dipropylcarbonate, methylpropylcarbonate, etc. and a mixture thereof. Additives selected from carbonates such as vinylenecarbonate, butylenecarbonate, etc., benzene compounds such as biphenyl, cyclohexylbenzene, etc., sulfides such as propanesultone, etc., and a mixture thereof are to be used in the electrolyte.

The mixture with electrolyte and solid polymer is to be used. Crystalline and amorphous inorganic solid electrolytes are to be used. The former includes LiI, Li₃N, Li_{1+X}M_{X}Ti_{2-X}(PO₄)₃ (M═Al, Sc, Y, La), Li_{0.5-3X}R_{0.5+X}TiO₃ (R═La, Pr, Nd, Sm), thio-LISICON such as Li_{4-X}Ge_{1-X}P_{X}S₄, and the latter includes the glass such as LiI—Li₂O—B₂O₅ system, Li₂O—SiO₂ system, LiI—Li₂S—B₂S₃ system, LiI—Li₂S—SiS₂ system, Li₂S—SiS₂—Li₃PO₄ system, etc.

Examples of the solute to be used for the non-aqueous electrolyte include LiPF₆, LiClO₄, LiBF₄, LiAsF₆, LiPF(CF₃)₅, LiPF₂(CF₃)₄, LiPF₃(CF₃)₃, LiPF₄(CF₃)₂, LiPF₅(CF₃), LiPF₃(C₂F₅)₃, LiCF₃SO₃, LiN(SO₃CF₃)₂, LiN(SO₃CF₂CF₃)₃, LiN(COCF₃)₂, LiN(COCF₂CF₃)₃, LiC₄BO₈, and a mixture thereof. LiPF₆ is preferable as the solute for the good cycle performance. The concentration is preferable in the range from 0.5 to 2.0 mol dm⁻³.

Examples of the separator to be used for the non-aqueous electrolyte include micro porous membrane such as nylon, cellulose acetate, nitro cellulose, polysulfone, polyacrylnytril, polyvinylidene fluoride, polyolefin.

The figuration of the non-aqueous electrolyte electrochemical cells is to be used as various types of prismatic, elliptical, coin, button, sheet, etc.

### EXAMPLES

The present invention is further described in the following examples, but the present invention should not be constructed as being limited by the following examples.

### Example 1

FePO₄ powder with the number-average particle diameter of 80 nm was used as material M. First, the paste was prepared by mixing FePO₄ 75 mass %, acetylene black (AB) 5 mass % as electro-conductive material, and polyvinylidene fluoride (PVDF) 20 mass % in N-methyl-2-pyrrolidone (NMP). Second, this paste was coated on the both sides of Al foil with 20 μm thickness and dried at 150° C. in vacuum. After that, the electrode containing FePO₄ was prepared by pressing on both sides with roll-press machine. Lithium was then absorbed into FePO₄ by immersion of this electrode into solution S1 obtained by dissolving 0.25 mol dm⁻³ naphthalene and saturated metallic lithium into diethylether (DEE) solvent for 3 days at 25° C. The electrode A1 containing FePO₄ absorbed lithium was finally obtained after washing by dimethylcarbonate and drying.

The paste was prepared by mixing natural graphite 92 mass % and PVDF 8 mass % in NMP. This paste was then coated on the both sides of Cu foil with 15 μm thickness and dried at 150° C. in vacuum. The electrode G containing natural graphite was finally prepared by pressing on both sides with roll-press machine.

The positive electrode A1, negative electrode B0, and 20 μm thickness polyethylene separator with the porosity of 40% were winded and inserted into the prismatic vessel with 48 mm high, 30 mm wide, and 4.2 mm thick. The non-aqueous electrolyte obtained by dissolving 1 mol dm⁻³ LiPF₆ into ethylenecarbonate (EC) and ethylmethylcarbonate (EMC) in the volume ratio of 1:1 was injected in this vessel. Thus, non-aqueous electrolyte electrochemical cell was obtained by using the process for the production of the present invention.

### Comparative Example 1

The non-aqueous electrochemical cell was prepared in the same manner as in Example 1 except that the solution (T1) obtained by dissolving n-butyllithium into diethylether (DEE) solvent was used instead of S1 as solution S.

### Comparative Example 2

The non-aqueous electrochemical cell was prepared in the same manner as in Example 1 except that the solution (T2) obtained by dissolving 0.25 mol dm⁻³ naphthalene and saturated LiPF₆ into diethylether (DEE) solvent was used instead of SI as solution S.

Electrochemical Test

Discharge capacity (1C mA) was measured under the condition that each cells were charged at the constant current of 450 mA (1C mA) to 4.5 V followed by the same value for 2 h in total and then discharged at the constant current of 450 mA (1C mA) to 0.5 V at 25° C.

After that, each cells were charged at the constant current of 450 mA (1C mA) to 4.5 V followed by the same value for 2 h in total and then discharged at the constant current of 4500 mA (10C mA) to 0.5 V at 25° C.

The ratio of the discharge capacity at the constant current of 10C mA to that of 1 C mA was calculated.

The test results of the non-aqueous electrolyte electrochemical cells obtained by the process for the production of example 1, comparative example 1, and comparative example 2 are shown in table 1.

TABLE 1

| | | | | Discharge | |
|---|---|---|---|---|---|
| | | Electrode | | capacity | *Ratio of |
| | | | Negative | (1C mA) | discharge |
| | Solution S | Positive electrode | electrode | mAh | capacity % |
| Example 1 | Metallic Li + | Lithium-absorbed | Natural | 412 | 88 |
| | naphthalene + | FePO₄ (A1) | graphite | | |
| | DEE (S1) | | (G0) | | |
| Comparative | n-butyllithium + | Lithium-absorbed | Natural | 281 | 69 |
| example 1 | DEE (T1) | FePO₄ | graphite | | |
| | | | (G0) | | |
| Comparative | LiPF₆ + | FePO₄ | Natural | 14 | 23 |
| example 2 | naphthalene + | | graphite | | |
| | DEE (T2) | | (G0) | | |

The following fact became clear from the result in table 1. The non-aqueous electrolyte electrochemical cells obtained by using metallic Li and naphthalene of polycyclic aromatic compound for solution S as example 1 gave larger discharge capacity and better performance at high current compared with that by using n-butyllithium as comparative example 1. This reason is suggested that because impurities such as polymer of alkane when lithium moves from n-butyllithium to FePO₄ produced and remained without removing in the washing process by dimethylcarbonate in the case of using T1 for solution S, discharge capacity and performance at high current of the cells deteriorated. On the other hand, the lithium-absorption mechanism in the case of using solution S1 is considered as follows. Firstly, the complex solution dissolved naphthalene anion and lithium ion is formed by the reason that an electron moves from metallic lithium to naphthalene. Secondly, lithium ion is absorbed to FePO₄ after an electron moves from naphthalene anion to FePO₄. Here, naphthalene anion returns to naphthalene, which has a role as catalyst in the lithium-absorption reaction. Impurities are not produced since a polymerization in the case of using n-butyllithium is not taken place after moving of electron from naphthalene anion to FePO₄.

Lithium-absorption reaction hardly proceeds in the case of using T2 as solution S, because naphthalene anion is not produced by using LiPF₆ instead of metallic lithium. Therefore, the discharge capacity of non-aqueous electrolyte electrochemical cell as comparative example 2 is significant small.

In addition, the same effect was also taken by using anthracene, phenanthrene, 1-methyl naphthalene, 2-methyl naphthalene, 1-fluoronaphthalene, 2-fluoronaphthalene, 2-ethyl naphthalene, naphthacene, pentacene, pyrene, picene, triphenylene, anthanthrene, acenaphthene, acenaphthylene, benzopyrene, benzofluorene, benzophenanthrene, benzofluoranthene, benzoperylene, coronene, chrysene, and hexabenzoperylene as polycyclic aromatic compound.

### Example 2

The non-aqueous electrochemical cell was prepared in the same manner as in Example 1 except that 1-methoxypropane (1-MP) was used instead of diethylether (DEE).

### Example 3

The non-aqueous electrochemical cell was prepared in the same manner as in Example 1 except that 1-methoxybutane (1-MB) was used instead of diethylether (DEE).

### Example 4

The non-aqueous electrochemical cell was prepared in the same manner as in Example 1 except that 1-methoxypentane (1-MPE) was used instead of diethylether (DEE).

### Example 5

The non-aqueous electrochemical cell was prepared in the same manner as in Example 1 except that 2-methoxybutane (1-MB) was used instead of diethylether (DEE).

### Example 6

The non-aqueous electrochemical cell was prepared in the same manner as in Example 1 except that i-butylmethylether (i-BME) was used instead of diethylether (DEE).

### Example 7

The non-aqueous electrochemical cell was prepared in the same manner as in Example 1 except that 1-methoxybutane (1-MB) instead of diethylether (DEE) and anthracene instead of naphthalene were used.

### Example 8

The non-aqueous electrochemical cell was prepared in the same manner as in Example 1 except that 1-methoxybutane (1-MB) instead of diethylether (DEE) and phenanthrene instead of naphthalene were used.

### Example 9

The non-aqueous electrochemical cell was prepared in the same manner as in Example 1 except that 1-methoxybutane (1-MB) instead of diethylether (DEE) and CoPO₄ instead of FePO₄ were used.

### Example 10

The non-aqueous electrochemical cell was prepared in the same manner as in Example 1 except that 1-methoxybutane (1-MB) instead of diethylether (DEE) and MnPO₄ instead of FePO₄ were used.

### Example 11

The non-aqueous electrochemical cell was prepared in the same manner as in Example 1 except that 1-methoxybutane (1-MB) instead of diethylether (DEE) and Fe₂O₃ instead of FePO₄ were used.

### Example 12

The non-aqueous electrochemical cell was prepared in the same manner as in Example 1 except that 1-methoxybutane (1-MB) instead of diethylether (DEE) and FeO instead of FePO₄ were used.

### Example 13

The non-aqueous electrochemical cell was prepared in the same manner as in Example 1 except that 1-methoxybutane (1-MB) instead of diethylether (DEE) and V₂O₅ instead of FePO₄ were used.

### Example 14

The non-aqueous electrochemical cell was prepared in the same manner as in Example 1 except that 1-methoxybutane (1-MB) instead of diethylether (DEE) and MnO₂ instead of FePO₄ were used.

### Example 15

The non-aqueous electrochemical cell was prepared in the same manner as in Example 1 except that 1-methoxybutane (1-MB) instead of diethylether (DEE) and TiS₂ instead of FePO₄ were used.

### Example 16

The non-aqueous electrochemical cell was prepared in the same manner as in Example 1 except that 1-methoxybutane (1-MB) instead of diethylether (DEE) and CoF₃ instead of FePO₄ were used.

### Comparative Example 3

The non-aqueous electrochemical cell was prepared in the same manner as in Example 1 except that tetrahydrofulane (THF) was used instead of diethylether (DEE).

### Comparative Example 4

The non-aqueous electrochemical cell was prepared in the same manner as in Example 1 except that tetrahydrofulane (THF) instead of diethylether (DEE) and anthracene instead of naphthalene were used.

### Comparative Example 5

The non-aqueous electrochemical cell was prepared in the same manner as in Example 1 except that tetrahydrofulane (THF) instead of diethylether (DEE) and phenanthrene instead of naphthalene were used.

### Comparative Example 6

The non-aqueous electrochemical cell was prepared in the same manner as in Example 1 except that hexane (HS) was used instead of diethylether (DEE).

### Comparative Example 7

The non-aqueous electrochemical cell was prepared in the same manner as in Example 1 except that hexane (HS) instead of diethylether (DEE) and anthracene instead of naphthalene were used.

### Comparative Example 8

The non-aqueous electrochemical cell was prepared in the same manner as in Example 1 except that hexane (HS) instead of diethylether (DEE) and phenanthrene instead of naphthalene were used.

### Comparative Example 9

The non-aqueous electrochemical cell was prepared in the same manner as in Example 1 except that dimethoxyethane (DME) was used instead of diethylether (DEE).

### Comparative Example 10

The non-aqueous electrochemical cell was prepared in the same manner as in Example 1 except that dimethoxyethane (DME) instead of diethylether (DEE) and anthracene instead of naphthalene were used.

### Comparative Example 11

The non-aqueous electrochemical cell was prepared in the same manner as in Example 1 except that dimethoxyethane (DME) instead of diethylether (DEE) and phenanthrene instead of naphthalene were used.

### Comparative Example 12

The non-aqueous electrochemical cell was prepared in the same manner as in Example 1 except that tetrahydrofulane (THF) instead of diethylether (DEE) and CoPO₄ instead of FePO₄ were used.

### Comparative Example 13

The non-aqueous electrochemical cell was prepared in the same manner as in Example 1 except that hexane (HS) instead of diethylether (DEE) and CoPO₄ instead of FePO₄ were used.

### Comparative Example 14

The non-aqueous electrochemical cell was prepared in the same manner as in Example 1 except that dimethoxyethane (DME) instead of diethylether (DEE) and CoPO₄ instead of FePO₄ were used.

The test results of the non-aqueous electrolyte electrochemical cells obtained by the process for the production of example 1-16, and comparative example 3-14 are shown in table 2.

TABLE 2

| | Solution S | | | | Discharge | |
|---|---|---|---|---|---|---|
| | | Polycyclic | | | capacity | *Ratio of |
| | | aromatic | Electrode | | (1C mA) | discharge |
| | Solvent | compound | Positive electrode | Negative electrode | mAh | capacity % |
| Ex. 1 | DEE | Naphthalene | Li-absorbed FePO₄ | Natural graphite (G0) | 412 | 88 |
| | | | (A1) | | | |
| Ex. 2 | 1-MP | Naphthalene | Li-absorbed FePO₄ | Natural graphite (G0) | 452 | 94 |
| Ex. 3 | 1-MB | Naphthalene | Li-absorbed FePO₄ | Natural graphite (G0) | 465 | 98 |
| Ex. 4 | 1-MPE | Naphthalene | Li-absorbed FePO₄ | Natural graphite (G0) | 450 | 94 |
| Ex. 5 | 2-MB | Naphthalene | Li-absorbed FePO₄ | Natural graphite (G0) | 452 | 91 |
| Ex. 6 | i-BME | Naphthalene | Li-absorbed FePO₄ | Natural graphite (G0) | 455 | 93 |
| Ex. 7 | 1-MB | Anthracene | Li-absorbed FePO₄ | Natural graphite (G0) | 456 | 88 |
| Ex. 8 | 1-MB | Phenanthrene | Li-absorbed FePO₄ | Natural graphite (G0) | 454 | 89 |
| Ex. 9 | 1-MB | Naphthalene | Li-absorbed CoPO₄ | Natural graphite (G0) | 450 | 96 |
| Ex. 10 | 1-MB | Naphthalene | Li-absorbed | Natural graphite (G0) | 453 | 95 |
| | | | MnPO₄ | | | |
| Ex. 11 | 1-MB | Naphthalene | Li-absorbed Fe₂O₃ | Natural graphite (G0) | 435 | 90 |
| Ex. 12 | 1-MB | Naphthalene | Li-absorbed FeO | Natural graphite (G0) | 442 | 90 |
| Ex. 13 | 1-MB | Naphthalene | Li-absorbed V₂O₅ | Natural graphite (G0) | 457 | 91 |
| Ex. 14 | 1-MB | Naphthalene | Li-absorbed MnO₂ | Natural graphite (G0) | 432 | 90 |
| Ex. 15 | 1-MB | Naphthalene | Li-absorbed TiS₂ | Natural graphite (G0) | 433 | 91 |
| Ex. 16 | 1-MB | Naphthalene | Li-absorbed CoF₃ | Natural graphite (G0) | 442 | 90 |
| Comp. Ex. 3 | THF | Naphthalene | Li-absorbed FePO₄ | Natural graphite (G0) | 298 | 72 |
| Comp. Ex. 4 | THF | Anthracene | Li-absorbed FePO₄ | Natural graphite (G0) | 298 | 74 |
| Comp. Ex. 5 | THF | Phenanthrene | Li-absorbed FePO₄ | Natural graphite (G0) | 295 | 69 |
| Comp. Ex. 6 | HS | Naphthalene | Li-absorbed FePO₄ | Natural graphite (G0) | 240 | 62 |
| Comp. Ex. 7 | HS | Anthracene | Li-absorbed FePO₄ | Natural graphite (G0) | 242 | 64 |
| Comp. Ex. 8 | HS | Phenanthrene | Li-absorbed FePO₄ | Natural graphite (G0) | 234 | 60 |
| Comp. Ex. 9 | DME | Naphthalene | Li-absorbed FePO₄ | Natural graphite (G0) | 305 | 71 |
| Comp. Ex. 10 | DME | Anthracene | Li-absorbed FePO₄ | Natural graphite (G0) | 301 | 69 |
| Comp. Ex. 11 | DME | Phenanthrene | Li-absorbed FePO₄ | Natural graphite (G0) | 298 | 68 |
| Comp. Ex. 12 | THF | Naphthalene | Li-absorbed CoPO₄ | Natural graphite (G0) | 210 | 55 |
| Comp. Ex. 13 | HS | Naphthalene | Li-absorbed CoPO₄ | Natural graphite (G0) | 221 | 58 |
| Comp. Ex. 14 | DME | Naphthalene | Li-absorbed CoPO₄ | Natural graphite (G0) | 215 | 55 |

The following fact became clear from the result in table 2. The non-aqueous electrolyte electrochemical cells obtained by using chain monoether as example 1-16 were found out to give larger discharge capacity and better performance at high current compared with that by using cyclic ether as comparative example 3-5, 12, alkane as comparative example 6-8, 13, chain diether as comparative example 9-11, 14. The reason is not clear that the non-aqueous electrolyte electrochemical cells obtained by using monoether with asymmetric molecule structure as example 2-6 gave much larger discharge capacity and much better performance at high current compared with that by using monoether with symmetric molecule structure as example 1. In addition, the same effect was also taken by using 2-methoxypentane, 1-methoxyhexane, 2-methoxyhexane, 3-methoxyhexane, 1-ethoxypropane, 1-ethoxybutane, 2-ethoxybutane, and isobutylmethylether as a solvent. The cell obtained by using 1-methoxybutane gave the largest discharge capacity and best performance at high current of all.

The reason is not clear that the non-aqueous electrolyte electrochemical cell obtained by using naphthalene as example 3 gave still better performance at high current compared with that by using the other polycyclic aromatic compounds as example 7 and example 8.

In addition, the same effect was also taken by using As₂O₃, V₂O₃, V₂O₄, CrO₃, Cr₂O₃, Mn₂O₃, Mn₃O₄, Fe₃O₄, NiF₃, FeS₂, and CoS₂, besides FePO₄, CoPO₄, MnPO₄, Fe₂O₃, FeO, V₂O₅, MnO₂, TiS₂, and CoF₃ as the examples for the material containing at least one sort of elements selected the transition metal, IIIB metal, Si, Ge, Sn, Pb, As, Sb, Bi in the periodic table.

The present invention is further described in the following examples, but the present invention should not be constructed as being limited by the following examples.

### Example 17

SiO with phase separated between Si and SiO₂ were used as the material M. The XRD pattern of this SiO obtained by using CuKa showed that one of the peaks (20) was in the range from 46° to 49°, whose half maximum full width B gave the following value of B<3° (20). First, the paste was prepared by mixing this SiO 75 mass %, AB 5 mass %, and PVDF 20 mass % in NMP. Second, this paste was coated on the both sides of Cu foil with 15 μm thickness and dried at 150° C. in vacuum. After that, the electrode (BO) containing SiO was prepared by pressing on both sides with roll-press machine. Lithium was then absorbed into SiO by immersion of this electrode into solution S1 obtained by dissolving 0.25 mol dm⁻³ naphthalene and saturated metallic lithium into diethylether (DEE) solvent for 3 days at 25° C. The electrode B1 containing SiO absorbed lithium was finally obtained after washing by dimethylcarbonate and drying.

The positive electrode A0, negative electrode B1, and 20 μm thickness polyethylene separator with the porosity of 40% were winded and inserted into the prismatic vessel with 48 mm high, 30 mm wide, and 4.2 mm thick. The non-aqueous electrolyte obtained by dissolving 1 mol dm⁻³ LiPF₆ into EC and EMC in the volume ratio of 1:1 was injected in this vessel. Thus, the non-aqueous electrolyte electrochemical cell was obtained.

### Comparative Example 15

LiFePO₄ was prepared by the mechanical reaction with LiOH.H₂O, Fe₂O₃, and (NH₄)₂HPO₄. First, the paste was prepared by mixing this LiFePO₄ 75 mass %, AB 5 mass %, and PVDF 20 mass % in NMP. Second, this paste was coated on the both sides of Al foil with 20 μm thickness and dried at 150° C. in vacuum. After that, the electrode containing the LiFePO₄ was prepared by pressing on both sides with roll-press machine.

This LiFePO₄ positive electrode, negative electrode B0, and 20 μm thickness polyethylene separator with the porosity of 40% were winded and inserted into the prismatic vessel with 48 mm high, 30 mm wide, and 4.2 mm thick. The non-aqueous electrolyte obtained by dissolving 1 mol dm⁻³ LiPF₆ into EC and EMC in the volume ratio of 1:1 was injected in this vessel. Thus, the non-aqueous electrolyte electrochemical cell was obtained.

### Comparative Example 16

The non-aqueous electrochemical cell was prepared in the same manner as in Example 17 except that the solution (T1) obtained by dissolving n-butyllithium into diethylether (DEE) solvent was used instead of S1 as solution S.

### Comparative Example 17

The non-aqueous electrochemical cell was prepared in the same manner as in Example 17 except that the solution (T2) obtained by dissolving 0.25 mol dm⁻³ naphthalene and saturated LiPF₆ into diethylether (DEE) solvent was used instead of SI as solution S.

Cell Thickness Test

Each cells were charged at the constant current of 450 mA (1C mA) to 4.5 V followed by the same value for 2 h in total. And then, thickness of the charged cell was measured in the central part by using slide gauge.

The test results of the non-aqueous electrolyte electrochemical cells obtained by the process for the production of example 17, comparative example 15-17 are shown in table 3.

TABLE 3

| | | | | Discharge | | |
|---|---|---|---|---|---|---|
| | | Electrode | | capacity | *Ratio of | Cell |
| | | Positive | Negative | (1C mA) | discharge | thickness |
| | Solution S | electrode | electrode | mAh | capacity % | mm |
| Ex. 17 | Metallic Li + | FePO₄ | Li-absorbed | 461 | 86 | 4.31 |
| | naphthalene + | (A0) | SiO (B1) | | | |
| | DEE (S1) | | | | | |
| Comp. | — | Li FePO₄ | SiO (B0) | 380 | 90 | 4.80 |
| Ex. 15 | | | | | | |
| Comp. | n-butyllithium + | FePO₄ | Li-absorbed | 295 | 66 | 4.65 |
| Ex. 16 | DEE (T1) | (A0) | SiO | | | |
| Comp. | LiPF₆ + | FePO₄ | SiO | 6 | 23 | 4.30 |
| Ex. 17 | naphthalene + | (A0) | | | | |
| | DEE (T2) | | | | | |

The following fact became clear from the result in table 3. The non-aqueous electrolyte electrochemical cells as example 17, which are obtained by using SiO as the material M containing at least one sort of elements selected the transition metal, IIIB metal, Si, Ge, Sn, Pb, As, Sb, Bi in the periodic table, were found out to give larger discharge capacity and better performance at high current. This fact is that this process for the product is also applicable to prepare a negative active material. Moreover, the thickness of the non-aqueous electrolyte electrochemical cell as example 17 in the charged state was smaller than that as comparative example 15. From this result, increase of cell thickness caused by volume expansion of SiO with charging was found to reduce by applying the present invention to the negative electrode. Since this method eliminates the need for the electrochemical method or attachment of lithium to the electrode, simplification and cost reduction of the process are to be attained.

The non-aqueous electrolyte electrochemical cells obtained by using metallic Li and naphthalene of polycyclic aromatic compound for solution S as example 17 gave larger discharge capacity and better performance at high current compared with that by using n-butyllithium as comparative example 16. This reason is suggested that because impurities such as polymer of alkane when lithium moves from n-butyllithium to SiO produced and remained without removing in the washing process by dimethylcarbonate in the case of using T1 for solution S, discharge capacity and performance at high current of the cell deteriorated.

Lithium-absorption reaction hardly proceeds in the case of using T2 as solution S, because naphthalene anion is not produced by using LiPF₆ instead of metallic lithium. Therefore, the discharge capacity of non-aqueous electrolyte electrochemical cell as comparative example 17 is significant small.

In addition, the same effect was also taken by using anthracene, phenanthrene, 1-methyl naphthalene, 2-methyl naphthalene, 1-fluoronaphthalene, 2-fluoronaphthalene, 2-ethyl naphthalene, naphthacene, pentacene, pyrene, picene, triphenylene, anthanthrene, acenaphthene, acenaphthylene, benzopyrene, benzofluorene, benzophenanthrene, benzofluoranthene, benzoperylene, coronene, chrysene, and hexabenzoperylene as polycyclic aromatic compound.

### Example 18

The non-aqueous electrochemical cell was prepared in the same manner as in Example 17 except that 1-methoxybutane (1-MB) was used instead of diethylether (DEE).

### Example 19

The non-aqueous electrochemical cell was prepared in the same manner as in Example 17 except that 1-methoxybutane (1-MB) instead of diethylether (DEE) and anthracene instead of naphthalene were used.

### Example 20

The non-aqueous electrochemical cell was prepared in the same manner as in Example 17 except that 1-methoxybutane (1-MB) instead of diethylether (DEE) and phenanthrene instead of naphthalene were used.

### Comparative Example 18

The non-aqueous electrochemical cell was prepared in the same manner as in Example 17 except that tetrahydrofulane (THF) was used instead of diethylether (DEE).

### Comparative Example 19

The non-aqueous electrochemical cell was prepared in the same manner as in Example 17 except that tetrahydrofulane (THF) instead of diethylether (DEE) and anthracene instead of naphthalene were used.

### Comparative Example 20

The non-aqueous electrochemical cell was prepared in the same manner as in Example 17 except that tetrahydrofulane (THF) instead of diethylether (DEE) and phenanthrene instead of naphthalene were used.

### Comparative Example 21

The non-aqueous electrochemical cell was prepared in the same manner as in Example 17 except that hexane (HS) was used instead of diethylether (DEE).

### Comparative Example 22

The non-aqueous electrochemical cell was prepared in the same manner as in Example 17 except that hexane (HS) instead of diethylether (DEE) and anthracene instead of naphthalene were used.

### Comparative Example 23

The non-aqueous electrochemical cell was prepared in the same manner as in Example 17 except that hexane (HS) instead of diethylether (DEE) and phenanthrene instead of naphthalene were used.

### Comparative Example 24

The non-aqueous electrochemical cell was prepared in the same manner as in Example 17 except that dimethoxyethane (DME) was used instead of diethylether (DEE).

### Comparative Example 25

The non-aqueous electrochemical cell was prepared in the same manner as in Example 17 except that dimethoxyethane (DME) instead of diethylether (DEE) and anthracene instead of naphthalene were used.

### Comparative Example 26

The non-aqueous electrochemical cell was prepared in the same manner as in Example 17 except that dimethoxyethane (DME) instead of diethylether (DEE) and phenanthrene instead of naphthalene were used.

The test results of the non-aqueous electrolyte electrochemical cells obtained by the process for the production of example 17-20, comparative example 18-26 are shown in table 4.

TABLE 4

| | Solution S | | Electrode | | Discharge | | |
|---|---|---|---|---|---|---|---|
| | | Polycyclic | | | capacity | *Ratio of | Cell |
| | | aromatic | Positive | Negative | (1C mA) | discharge | thickness |
| | Solvent | compound | electrode | electrode | mAh | capacity % | mm |
| Ex. 17 | DEE | Naphthalene | FePO₄ | Li-absorbed | 461 | 86 | 4.31 |
| | | | (A0) | SiO (B1) | | | |
| Ex. 18 | 1-MB | Naphthalene | FePO₄ | Li-absorbed | 472 | 98 | 4.28 |
| | | | (A0) | SiO | | | |
| Ex. 19 | 1-MB | Anthracene | FePO₄ | Li-absorbed | 459 | 91 | 4.33 |
| | | | (A0) | SiO | | | |
| Ex. 20 | 1-MB | Phenanthrene | FePO₄ | Li-absorbed | 460 | 91 | 4.33 |
| | | | (A0) | SiO | | | |
| Comp. Ex. 18 | THF | Naphthalene | FePO₄ | Li-absorbed | 302 | 71 | 4.65 |
| | | | (A0) | SiO | | | |
| Comp. Ex. 19 | THF | Anthracene | FePO₄ | Li-absorbed | 314 | 69 | 4.71 |
| | | | (A0) | SiO | | | |
| Comp. Ex. 20 | THF | Phenanthrene | FePO₄ | Li-absorbed | 319 | 67 | 4.70 |
| | | | (A0) | SiO | | | |
| Comp. Ex. 21 | HS | Naphthalene | FePO₄ | Li-absorbed | 299 | 70 | 4.64 |
| | | | (A0) | SiO | | | |
| Comp. Ex. 22 | HS | Anthracene | FePO₄ | Li-absorbed | 301 | 67 | 4.69 |
| | | | (A0) | SiO | | | |
| Comp. Ex. 23 | HS | Phenanthrene | FePO₄ | Li-absorbed | 304 | 64 | 4.71 |
| | | | (A0) | SiO | | | |
| Comp. Ex. 24 | DME | Naphthalene | FePO₄ | Li-absorbed | 289 | 67 | 4.65 |
| | | | (A0) | SiO | | | |
| Comp. Ex. 25 | DME | Anthracene | FePO₄ | Li-absorbed | 291 | 62 | 4.72 |
| | | | (A0) | SiO | | | |
| Comp. Ex. 26 | DME | Phenanthrene | FePO₄ | Li-absorbed | 295 | 63 | 4.72 |
| | | | (A0) | SiO | | | |

The following fact became clear from the result in table 4. The non-aqueous electrolyte electrochemical cells obtained by using chain monoether as example 17-20 were found out to give larger discharge capacity and better performance at high current compared with that by using cyclic ether as comparative example 18-20, alkane as comparative example 21-23, chain diether as comparative example 24-26. The reason is not clear that the non-aqueous electrolyte electrochemical cells obtained by using monoether with asymmetric molecule structure as example 18-20 gave much larger discharge capacity and much better performance at high current compared with that by using monoether with symmetric molecule structure as example 17. In addition, the same effect was also taken by using 2-methoxypentane, 1-methoxyhexane, 2-methoxyhexane, 3-methoxyhexane, 1-ethoxypropane, 1-ethoxybutane, 2-ethoxybutane, and isobutylmethylether as a solvent. The cell obtained by using 1-methoxybutane gave the largest discharge capacity and best performance at high current of all.

The reason is not clear that the non-aqueous electrolyte electrochemical cell obtained by using naphthalene as example 18 gave still better performance at high current compared with that by using the other polycyclic aromatic compounds as example 19 and example 20.

In addition, the same effect was also taken by using GeO, GeO₂, PbO, PbO₂, Pb₂O₃, Pb₃O₄, Sb₂O₃, Sb₂O₄, Sb₂O₅, Bi₂O₃, Bi₂O₄, Bi₂O₅, SnO, SnO₂, SnSi_{0.01}O_{1.09}, SnGe_{0.01}O_{1.09}, SnPb_{0.01}O_{1.09}, SnB₂O₄, SnSiAl_{0.2}P_{0.2}O_{0.3}, In₂O₃, Tl₂O, Tl₂O₃, SnS, SnS₂, GeS, GeS₂, Sb₂S₅, Si₃N₄, AlN, CoO, CO₃O₄, CO₂O₃, NiO, TiO₂, TiO, MnO, CuO, Cu₂O, ZnO, CoS, Mn₂P, CO₂P, and Fe₃P, besides SiO as the example for the material containing at least one sort of elements selected the transition metal, IIIB metal, Si, Ge, Sn, Pb, As, Sb, Bi in the periodic table.

1. A process for a production of lithium-containing material by a lithium absorption reaction proceeding on contact between material M and a solution obtained by dissolving metallic Li and polycyclic aromatic compound into chain monoether, where the material M contains at least one sort of elements selected from a transition metal, IIIb metal, IVb metal, and Vb metal in a periodic table.

2. The process for the production of lithium-containing material according to claim 1, where the molecule structure of chain monoether is asymmetric.

3. The process for the production of lithium-containing material according to claim 1, where the chain monoether is 1-methoxybutane.

4. The process for the production of lithium-containing material according to claim 1, where the polycyclic aromatic compound is at least one sort selected from naphthalene, phenanthrene, and anthracene.

5. The process for the production of lithium-containing material according to claim 1, where the polycyclic aromatic compound is naphthalene.

6. The process for the production of lithium-containing material according to claim 1, where the material M is at least one sort selected from SiO, GeO, GeO₂, PbO, PbO₂, Pb₂O₃, Pb₃O₄, Sb₂O₃, Sb₂O₄, Sb₂O₅, Bi₂O₃, Bi₂O₄, Bi₂O₅, SnO, SnO₂, SnSi_{0.01}O_{1.09}, SnGe_{0.01}O_{1.09}, SnPb_{0.01}O_{1.09}, SnP_{0.01}O_{1.09}, SnB₂O₄, SnSiAl_{0.2}P_{0.2}O_{0.3}, In₂O₃, Tl₂O, Tl₂O₃, SnS, SnS₂, GeS, GeS₂, Sb₂S₅, Si₃N₄, AlN, CoO, CO₃O₄, CO₂O₃, NiO, TiO₂, TiO, MnO, CuO, Cu₂O, ZnO, CoS, Mn₂P, CO₂P, Fe₃P As₂O₃, V₂O₃, V₂O₄, V₂O₅, CrO₃, Cr₂O₃, Mn₂O₃, Mn₃O₄, MnO₂, Fe₃O₄, Fe₂O₃, FeO, FeS₂, CoS₂, TiS₂, FePO₄, CoPO₄, MnPO₄, NiF₃, and CoF₃.

7. The process for the production of lithium-containing material according to claim 1, where the material M is SiO.

8. The process for the production of lithium-containing material according to claim 1, where the material M is at least one sort selected from FePO₄, CoPO₄, and MnPO₄.

9. A process for a production of a non-aqueous electrolyte electrochemical cell using an electrode with the lithium-containing material according to claim 1.

10. The process for the production of the non-aqueous electrolyte electrochemical cell according to claim 9, using the electrode with the lithium-containing material obtained by the process according to claim 2.

11. The process for the production of the non-aqueous electrolyte electrochemical cell according to claim 9, using the electrode with the lithium-containing material obtained by the process according to claim 3.

12. The process for the production of the non-aqueous electrolyte electrochemical cell according to claim 9, using the electrode with the lithium-containing material obtained by the process according to claim 4.

13. The process for the production of the non-aqueous electrolyte electrochemical cell according to claim 9, using the electrode with the lithium-containing material obtained by the process according to claim 5.

14. The process for the production of the non-aqueous electrolyte electrochemical cell according to claim 9, using the electrode with the lithium-containing material obtained by the process according to claim 6.

15. The process for the production of the non-aqueous electrolyte electrochemical cell according to claim 9, using the electrode with the lithium-containing material obtained by the process according to claim 7.

16. The process for the production of the non-aqueous electrolyte electrochemical cell according to claim 9, using the electrode with the lithium-containing material obtained by the process according to claim 8.
